(19) United States
(12) Patent Application Publication
(10) Pub. No.: US 2023/0313590 A1
(43) Pub. Date: Oct. 5, 2023

(54) HINGE BASED COUNTERBALANCE MECHANISM

(71) Applicant: MAGNA CLOSURES INC., NEWMARKET (CA)

(72) Inventors: KURT MATTHEW SCHATZ, AURORA (CA); J. R. SCOTT MITCHELL, NEWMARKET (CA)

(21) Appl. No.: 18/206,433

(22) Filed: Jun. 6, 2023

Related U.S. Application Data
(63) Continuation of application No. 16/429,819, filed on Jun. 3, 2019.
(60) Provisional application No. 62/680,237, filed on Jun. 4, 2018.
(60) Provisional application No. 62/730,256, filed on Sep. 12, 2018.

(51) Int. Cl. E05F 15/611; B60J 5/10; B60J 5/04; B62D 25/08; B62D 25/12

(52) U.S. Cl. CPC E05F 15/611; B60J 5/101; B60J 5/047; B62D 25/087; B62D 25/12; E05F 1/1238

(57) ABSTRACT

A hinge based counterbalance mechanism for operating a hinge of a closure panel of a vehicle to assist in opening and closing of the closure panel between a closed position and an open position about a pivot axis, the hinge drive mechanism including: a hinge having a body side portion for connecting to a body of the vehicle and a panel side portion for connecting to the closure panel, the body side portion and the panel side portion coupled via the pivot axis; a torsion element having a fixed end coupled to the body and a free end coupled to the body side portion, the fixed end inhibited from rotating relative to the free end and the free end able to rotate about a torsion axis of the torsion element; and a mechanical coupling mechanism coupling the free end to the panel side portion, the mechanical coupling mechanism providing for variability in torque output of the torsion element applied from the torsion element to the panel side portion as the hinge moves between the open position and the closed position.

### CROSS-REFERENCE TO RELATED APPLICATIONS

This application is a continuation of U.S. patent application Ser. No. 16/429,819, filed Jun. 3, 2019, and entitled “HINGE BASED COUNTERBALANCE MECHANISM”, which claims priority from U.S. Provisional Patent Application No. 62/680,237, filed on Jun. 4, 2018, and U.S. Provisional Patent Application No. 62/730,256, filed on Sep. 12, 2018; the entire contents of which are hereby incorporated by reference herein.

### FIELD

This disclosure relates to hinge based open and close mechanisms for a closure panel.

### BACKGROUND

Some vehicles are equipped with a closure panel, such as a lift gate, which is driven between an open position (position 2) and a closed position (position 1) using an electrically driven lift or opening system. Disadvantages of the current systems include bulky form factors which take up valuable vehicle cargo space, for example, occupying space along the vertical supports delimiting the opening of a rear liftgate. As such, the current systems tend to limit the size of access through the opening and into the interior cargo space, require additional lift support systems in tandem such as gas struts and other counterbalance mechanisms, have an unacceptable impact on manual open and close efforts requiring larger operator applied manual force at the panel handle, and/or temperature effects resulting in variable manual efforts required by the operator due to fluctuations in ambient temperature.

Automotive liftgates typically use struts for power operation. The counterbalance torques are provided by the springs and internal friction devices. In order to reduce the strut diameter and increase daylight opening of the aperture, the springs could be removed from the struts. The counterbalance torque must be provided by some other means.

### SUMMARY

It is an object of the present invention to provide a hinge based counterbalance mechanism that obviates or mitigates at least one of the above presented disadvantages.

One aspect provided is a hinge based counterbalance mechanism for operating a hinge of a closure panel of a vehicle to assist in opening and closing of the closure panel between a closed position and an open position about a pivot axis, the hinge drive mechanism including: a hinge having a body side portion for connecting to a body of the vehicle and a panel side portion for connecting to the closure panel, the body side portion and the panel side portion coupled via the pivot axis; a torsion element having a fixed end coupled to the body and a free end coupled to the body side portion, the fixed end inhibited from rotating relative to the free end and the free end able to rotate about a torsion axis of the torsion element; and a mechanical coupling mechanism coupling the free end to the panel side portion, the mechanical coupling mechanism providing for variability in torque output of the torsion element applied from the torsion element to the panel side portion as the hinge moves between the open position and the closed position.

A second aspect provided is a hinge based counterbalance mechanism for operating a hinge of a closure panel of a vehicle to assist in opening and closing of the closure panel between a closed position and an open position about a pivot axis, the hinge based counterbalance mechanism including: a hinge having a body side portion for connecting to a body of the vehicle and a panel side portion for connecting to the closure panel, the body side portion and the panel side portion coupled via the pivot axis; a torsion element having a fixed end coupled to the body and a free end, the fixed end inhibited from rotating relative to the free end and the free end able to rotate about a torsion axis of the torsion element; and a mechanical coupling mechanism coupling the free end to the panel side portion, the mechanical coupling mechanism providing for variability in torque output of the torsion element applied from the torsion element to the panel side portion as the hinge moves between the open position and the closed position.

A third aspect provided is a hinge based counterbalance mechanism for operating a hinge of a closure panel of a vehicle to assist in opening and closing of the closure panel between a closed position and an open position about a pivot axis, the hinge based counterbalance mechanism including: a hinge having a body side portion for connecting to a body of the vehicle and a panel side portion for connecting to the closure panel, the body side portion and the panel side portion coupled via the pivot axis; a resilient element having a fixed end coupled to the body and a free end, the fixed end inhibited from rotating relative to the free end and the free end able to rotate about a torsion axis of the resilient element; and a mechanical coupling mechanism coupling the free end to the panel side portion, the mechanical coupling mechanism providing for variability in torque output of the resilient element applied from the resilient element to the panel side portion as the hinge moves between the open position and the closed position.

A fourth aspect provided is a hinge based counterbalance mechanism for operating a hinge of a closure panel of a vehicle to assist in opening and closing of the closure panel between a closed position and an open position about a pivot axis, the hinge based counterbalance mechanism including: a hinge having a body side portion for connecting to a body of the vehicle and a panel side portion for connecting to the closure panel, the body side portion and the panel side portion coupled via the pivot axis; a resilient element having a fixed end coupled to the body and a free end, the fixed end inhibited from translating relative to the free end and the free end able to translate along a travel axis of the resilient element; and a mechanical coupling mechanism coupling the free end to the panel side portion, the mechanical coupling mechanism providing for variability in output of the resilient element applied from the resilient element to the panel side portion as the hinge moves between the open position and the closed position.

In accordance with another aspect, there is provided a method of opening and closing a closure panel of a vehicle between a closed position and an open position, comprising the steps of providing a hinge having a body side portion for connecting to a body of the vehicle and a panel side portion for connecting to the closure panel, providing a torsion element having a free end and a fixed end coupled to either of the body side portion or the body, the fixed end inhibited from rotating relative to the free end and the free end able to rotate about a torsion axis of the torsion element, and coupling the free end to the panel side portion using a mechanical coupling mechanism, the mechanical coupling mechanism providing for variability in torque output of the torsion element applied from the torsion element to the panel side portion as the hinge moves between the open position and the closed position.

In accordance with another aspect there is provided a counterbalance mechanism to assist in opening and closing of the closure panel between a closed position and an open position about a pivot axis, the counterbalance mechanism including, a torsion element having a free end and a fixed end coupled to either of the closure panel or the body, the fixed end inhibited from rotating relative to the free end and the free end able to rotate about a torsion axis of the torsion element, and a mechanical coupling mechanism coupling the free end to the other of the closure panel or the body, the mechanical coupling mechanism providing for variability in torque output of the torsion element applied from the torsion element to the other of the closure panel or the body as the closure panel moves relative to the body between the open position and the closed position.

In accordance with another aspect, there is provided a method of opening and closing a closure panel of a vehicle between a closed position and an open position, comprising the steps of providing a torsion element having a free end and a fixed end coupled to either of the closure panel or the body, the fixed end inhibited from rotating relative to the free end and the free end able to rotate about a torsion axis of the torsion element, and coupling the free end to the other of the closure panel and the body using a mechanical coupling mechanism, the mechanical coupling mechanism providing for variability in torque output of the torsion element applied from the torsion element to the other of the closure panel and the body as the closure panel move relative to the body between the open position and the closed position.

Other aspects, including methods of operation, and other embodiments of the above aspects will be evident based on the following description and drawings.

### BRIEF DESCRIPTION OF THE DRAWINGS

Reference is made, by way of example only, to the attached figures, wherein:

FIG. 1A is a side view of a vehicle with one or more closure panels;

FIG. 1B is a rear perspective view of a vehicle with one or more closure panels illustrating the hinge based counterbalance mechanism positioned along a hinge axis;

FIG. 2 is an alternative embodiment of the vehicle of FIG. 1;

FIG. 3 is an alternative embodiment of the vehicle of FIG. 1;

FIG. 4A shows a perspective view of an embodiment of the hinge based counterbalance mechanism of FIG. 2 illustratively positioned along a hinge axis of a liftgate;

FIG. 4B shows the embodiment of the hinge based counterbalance mechanism of FIG. 4A in front perspective view isolated from the liftgate;

FIG. 5 shows a rear perspective view of the hinge based counterbalance mechanism of FIG. 4B;

FIG. 6 shows a front perspective view of the hinge based counterbalance mechanism of FIG. 5 coupled to gate brackets;

FIG. 7A shows a side view of the hinge based counterbalance mechanism of FIG. 4B;

FIG. 7B shows a perspective view of one end of the hinge based counterbalance mechanism of FIG. 4B;

FIG. 8 shows a perspective view of one end of the hinge based counterbalance mechanism of FIG. 4B with multi bar linkage;

FIGS. 9 to 19 show various degrees of operation of the hinge of the hinge based counterbalance mechanism of FIG. 4B;

FIG. 20 is a table of example operational parameters of the hinge based counterbalance mechanism of FIGS. 9-19;

FIG. 21 is a graph of torque values showing comparison between torsion rod and liftgate torque as compared to target output torque for the operational parameters of FIG. 20;

FIG. 22 shows an alternative embodiment of the hinge based counterbalance mechanism of FIG. 4B;

FIG. 23 shows a still further alternative embodiment of the hinge based counterbalance mechanism of FIG. 4B;

FIG. 24 shows a still further alternative embodiment of the hinge based counterbalance mechanism of FIG. 4B;

FIGS. 25 to 33 show various degrees of operation of the hinge of the hinge based counterbalance mechanism of FIG. 4B;

FIG. 34 is a perspective view of an end configuration of the torsion element of the hinge based counterbalance mechanism of FIG. 24;

FIG. 35 is a graph of torque values showing comparison between torsion rod and liftgate torque as compared to target output torque for the operational parameters of the hinge based counterbalance mechanism of FIG. 24;

FIG. 36 shows a perspective view of one end of the hinge based counterbalance mechanism of FIG. 24 with multi bar linkage;

FIG. 37 is a further graph of torque values showing comparison between torsion rod torque as compared to dynamic opening and closing effort for the hinge based counterbalance mechanism of FIG. 24;

FIG. 38 shows a still further alternative embodiment of the hinge based counterbalance mechanism of FIG. 24;

FIGS. 39a and 39b show a still further alternative embodiment of the hinge based counterbalance mechanism of FIG. 4B;

FIG. 40 shows a still further alternative embodiment of the hinge based counterbalance mechanism of FIG. 4B;

FIGS. 41 and 42 shows various example sensor and lighting assemblies for the hinge based counterbalance mechanism of FIG. 24; and

FIG. 43 is a flowchart of a method of operating a closure panel, in accordance with an illustrative example.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

In the following description, details are set forth to provide an understanding of the disclosure. In some instances, certain software, circuits, structures, techniques and methods have not been described or shown in detail in order not to obscure the disclosure. The term “controller” is used herein to refer to any machine for processing data, including the data processing systems, computer systems, modules, electronic control units (“ECUs”), microprocessors or the like for providing control of the systems described herein, which may include hardware components and/or software components for performing the processing to provide the control of the systems described herein. A computing device is another term used herein to refer to any machine for processing data including microprocessors or the like for providing control of the systems described herein. The present disclosure may be implemented in any computer programming language (e.g. control logic) provided that the operating system of the control unit provides the facilities that may support the requirements of the present disclosure. Any limitations presented would be a result of a particular type of operating system or computer programming language and would not be a limitation of the present disclosure. The present disclosure may also be implemented in hardware or in a combination of hardware and software.

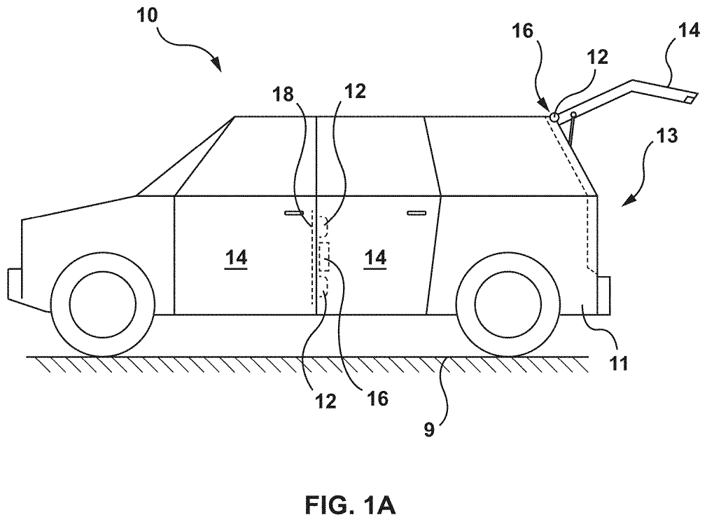

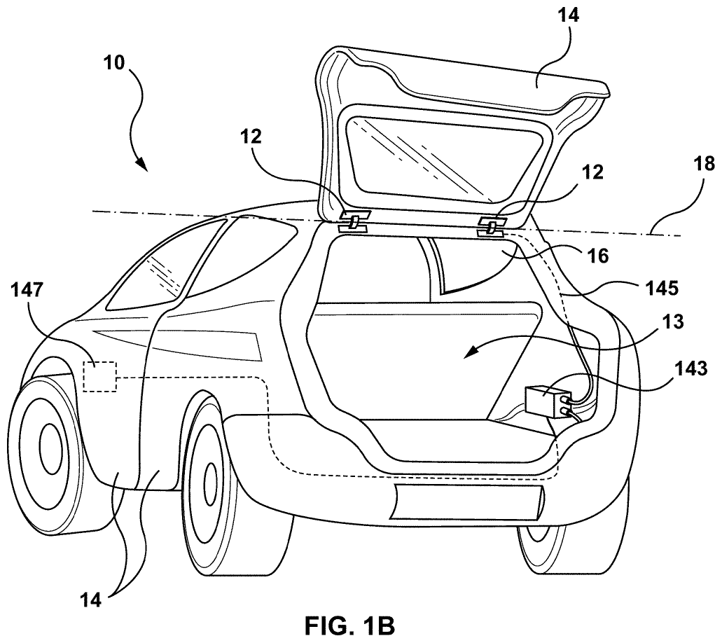

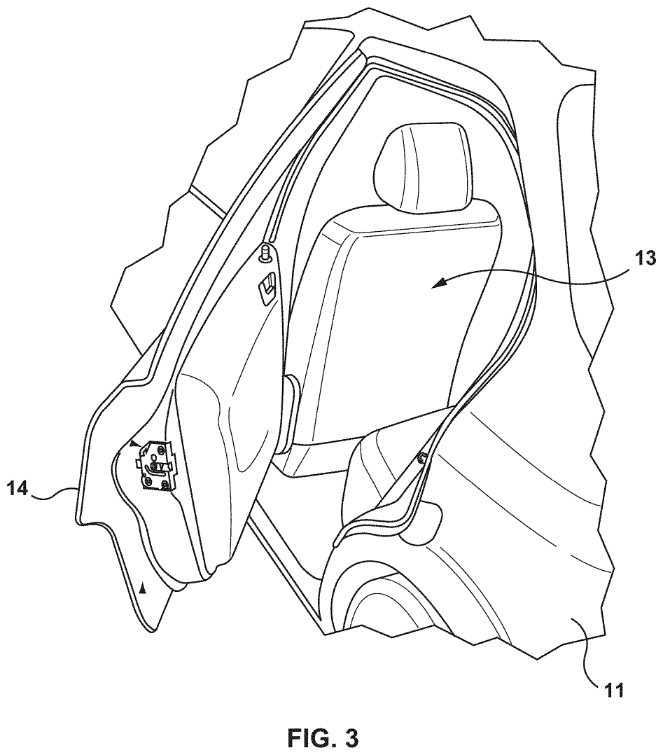

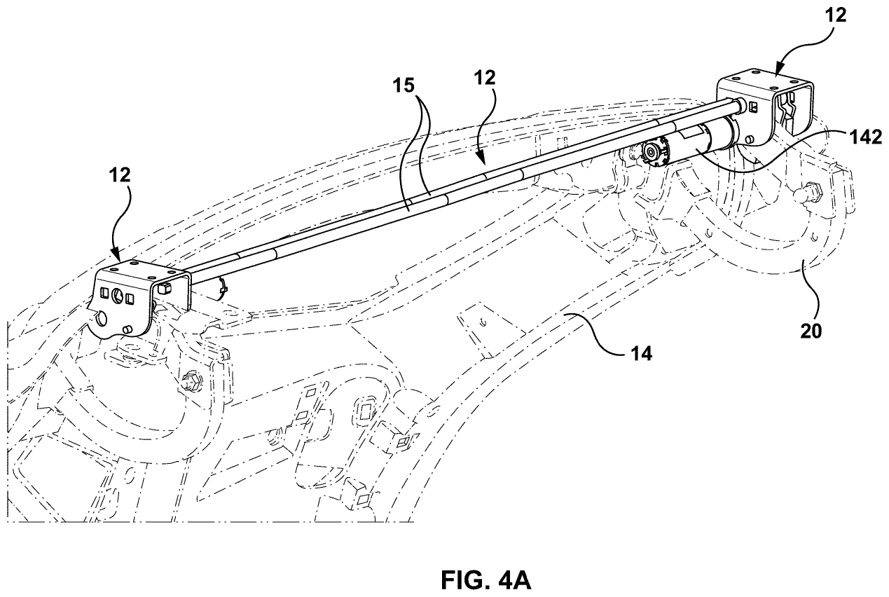

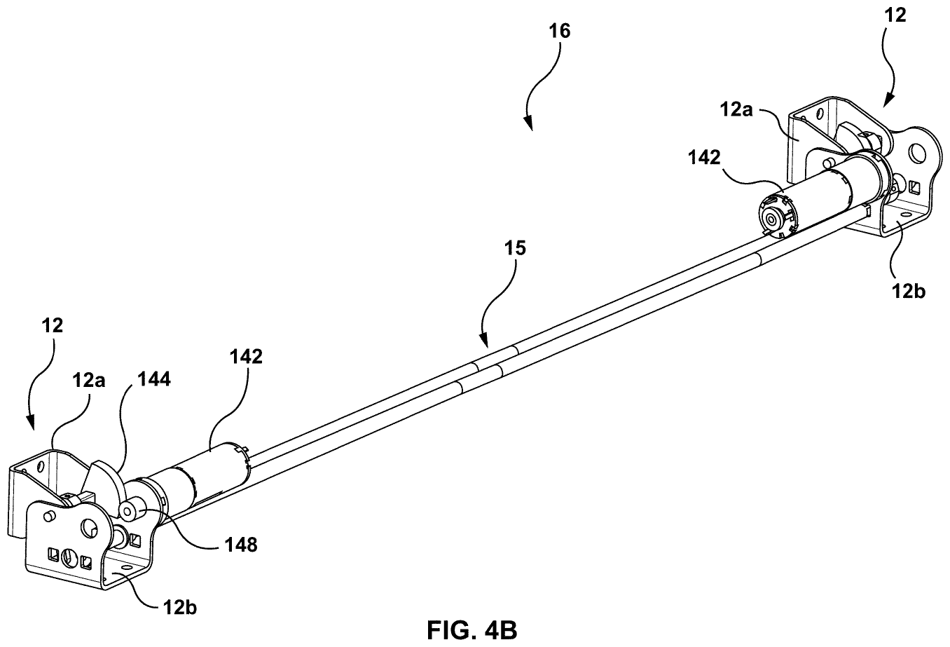

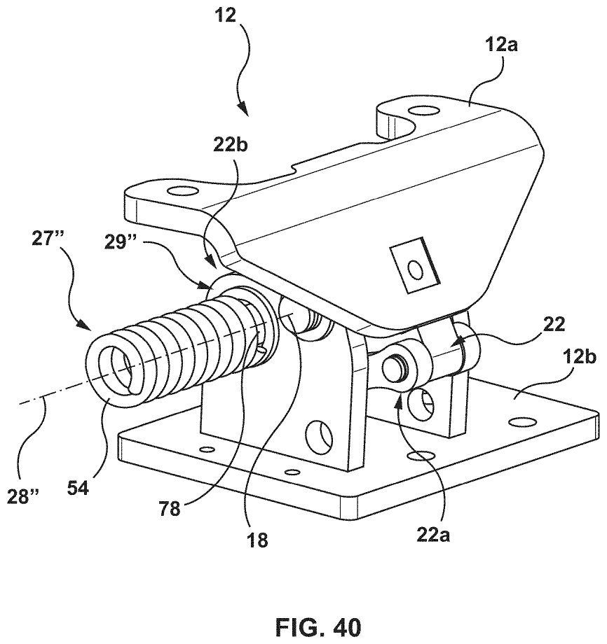

Referring to FIGS. 1A and 1B, provided is a hinge based counterbalance mechanism 16 (e.g. configured using one or more torsion elements 15—see FIG. 1b) that can be used advantageously with vehicle closure panels 14 to provide for open and close operations for the closure panel(s) 14 of vehicles 10. Other applications of the hinge based counterbalance mechanism 16, in general for closure panels 14 both in and outside of vehicle applications, include advantageously assisting in optimization of overall hold and manual effort forces for closure panel 14 operation. It is recognized as well that the hinge based counterbalance mechanism 16 examples provided below can be used advantageously as the sole means of open and close assistance for closure panels 14 or can be used advantageously in combination (e.g. in tandem) with other closure panel 14 biasing members (e.g. spring loaded hinges, biasing struts, etc.). In particular, the hinge based counterbalance mechanism 16 can be used to provide or otherwise assist in a holding force (or torque) for the closure panel 14. Further, it is recognized that the hinge based counterbalance mechanism 16 can be integrated in conjunction with hinges 12 (see FIGS. 1b,4b) of the closure panel 14 such as a component of a closure panel 14 assembly, as further described below. The hinges 12 can have a panel side portion 12a for connecting the hinge based counterbalance mechanism 16 to the closure panel 14 and a body side portion 12b for connecting the hinge based counterbalance mechanism 16 to a vehicle body 11. For example, the panel side portion 12a can be connected a gate bracket 20 (se FIG. 4A). The torsion element(s) 15 of the direct hinge drive mechanism 16 can be of a solid bar or hollow tube type, as desired. Further, the torsion elements 15 can be a resilient element 54 (e.g. such as a coil spring—see FIG. 40).

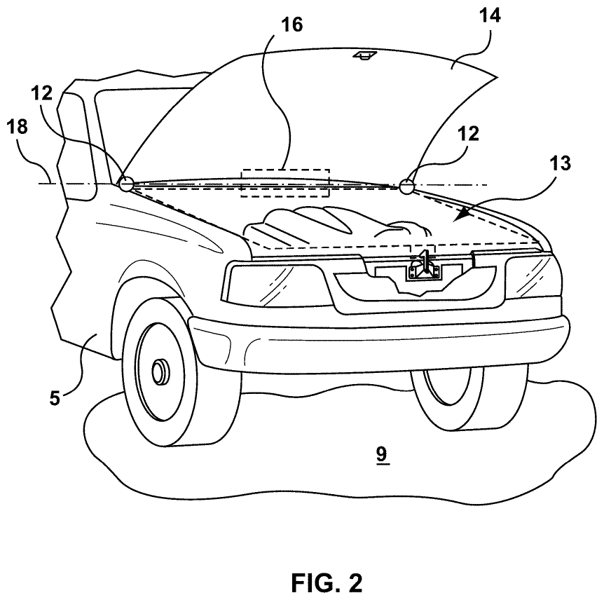

Referring again to FIGS. 1A and 1B, shown is the vehicle 10 with a vehicle body 11 having one or more closure panels 14. For vehicles 10, the closure panel 14 can be referred to as a partition or door, typically hinged, but sometimes attached by other mechanisms such as tracks, in front of an opening 13 which is used for entering and exiting the vehicle 10 interior by people (see FIG. 3) and/or cargo. It is also recognized that the closure panel 14 can be used as an access panel for vehicle 10 systems such as engine compartments (see FIG. 2) and also for traditional trunk compartments of automotive type vehicles 10. The closure panel 14 can be opened to provide access to the opening 13, or closed to secure or otherwise restrict access to the opening 13. For example decklids, trunks, hoods, tailgates. Also closure panel 14 can be for a center console with hinged lid configuration, glove compartments, pickup truck covers, windows and the like. It is also recognized that there can be one or more intermediate hold positions of the closure panel 14 between a fully open position and fully closed position, as provided at least in part by the torsion element 15. For example, the torsion element 15 can assist in biasing movement of the closure panel 14 away from one or more intermediate hold position(s), also known as Third Position Hold(s) (TPHs) or Stop-N-Hold(s), once positioned therein. It is also recognized that the torsion element(s) 15 can be provided as a component of the closure panel 14 assembly.

The closure panel 14 can be opened manually and/or powered electronically via the hinge based counterbalance mechanism 16, where powered closure panels 14 can be found on minivans, high-end cars, or sport utility vehicles (SUVs) and the like. Additionally, one characteristic of the closure panel 14 is that due to the weight of materials used in manufacture of the closure panel 14, some form of force assisted open and close mechanism (or mechanisms) are used to facilitate operation of the open and close operation by an operator (e.g. vehicle driver) of the closure panel 14. The force assisted open and close mechanism(s) can be provided by the torsion element(s) 15, a motor 142, and/or any biasing members external to the hinge based counterbalance mechanism 16 (e.g. spring loaded hinges, spring loaded struts, gas loaded struts, electromechanical struts, etc.), when used as part of the closure panel 14 assembly. In an embodiment, the torsion element(s) 15, a motor 142 may provide both the force assist and counterbalance for the closure panel 14 assembly.

In terms of vehicles 10, the closure panel 14 may be a lift gate as shown in FIGS. 1A and 1B, or it may be some other kind of closure panel 14, such as an upward-swinging vehicle door (i.e. what is sometimes referred to as a gull-wing door) or a conventional type of door that is hinged at a front-facing or back-facing edge of the door (see FIG. 3), and so allows the door to swing (or slide) away from (or towards) the opening 13 in the body 11 of the vehicle 10. Canopy doors are a type of door that sits on top of the vehicle 10 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 11 of the vehicle at the front, side or back of the door, as the application permits.

Referring again to FIG. 1A, in the context of a vehicle application of a closure panel by example only, the closure panel 14 is movable between a closed position (shown in dashed outline) and an open position (shown in solid outline). In the embodiment shown, the closure panel 14 pivots between the open position and the closed position about a pivot axis 18 (see FIG. 2), which can be configured as horizontal or otherwise parallel to a support surface 9 of the vehicle 10. In other embodiments, the pivot axis 18 may have some other orientation such as vertical (see FIG. 1A) or otherwise extending at an angle outwards from the support surface 9 of the vehicle 10.

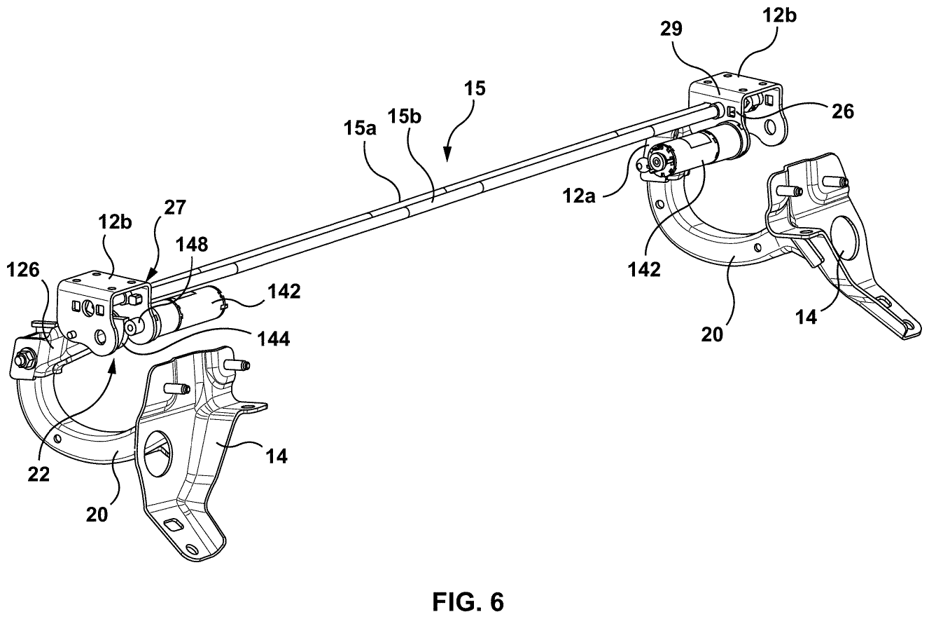

Referring to 4B, 5, and 6, shown is the hinge based counterbalance mechanism 16 having a pair of torsion elements 15a (e.g. one for each hinge 12) coupled on one end to a hinge 12 and on the other end to the other hinge 12. As shown by example, the torsion elements 15 are coupled to the body side portions 12b of the hinges 12. Each hinge 12 can have an electrically driven motor 142 coupled (via a drive shaft 148) to the panel side portion 12a of the hinges 12 via a gear 144 (e.g. one or more gears). As shown in FIGS. 7A, 7B, the gear 144 is mounted to the panel side portion 12a on the pivot axis 18, such that rotation (e.g. as driven by the drive shaft 148) of the gear 144 about the pivot axis 18 also results in conjoint rotation of the panel side portion 12a also about the pivot axis 18. As further described below, as the panel side portion 12a rotates about the pivot axis 18, the respective torsion element 15 associated with each hinge 12 is twisted or untwisted, thus loading or unloading (depending on the direction of rotation) torque of the torsion element 15. It is recognized that at one free end 29 the torsion element 15 is allowed to rotate (about respective torsion axis 28a,b) in an aperture 26 (of one body side portion 12b of the pair of hinges 12) while at the other fixed end 27 the torsion element 15 is fixedly mounted to the other body side portion 12b of the pair of hinges 12 (see FIG. 6) and thus inhibited from rotating.

As shown in FIGS. 6, 7B and 8, the hinge 12 has the motor 142 mounted on the body side portion 12b and coupled operationally to the panel side portion 12a (e.g. via the gear 144 and drive shaft 148) about the pivot axis 18 via a pivot member 24. The gear 144 is connected to the pivot member 24 mounted to the panel side portion 12a about the pivot axis 18, such that both the pivot member 24 and the panel side portion 12a rotate conjointly, as one example of the operational coupling between the motor 142 and the panel side portion 12a of the hinge 12. A mechanical coupling mechanism (e.g. a multi bar linkage) 22 is connected to the pivot member 24 at one end 22a and to one of the torsion elements 15a at the other end 22b, thus providing variability in mechanical advantage between the torsion element 15a and the panel side portion 12a of the hinge 12. It is recognized that the torsion element 15a is positioned in the aperture 26 of the body side portion 12b, such that the torsion element 15a is free to rotate about itself (e.g. along torsion axis 28a) at the one free end 29.

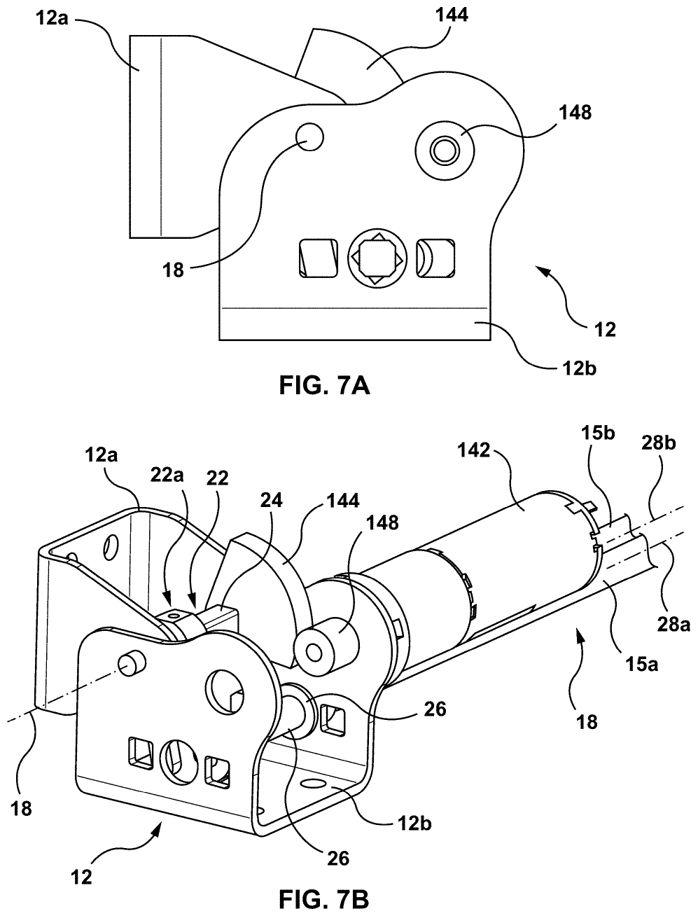

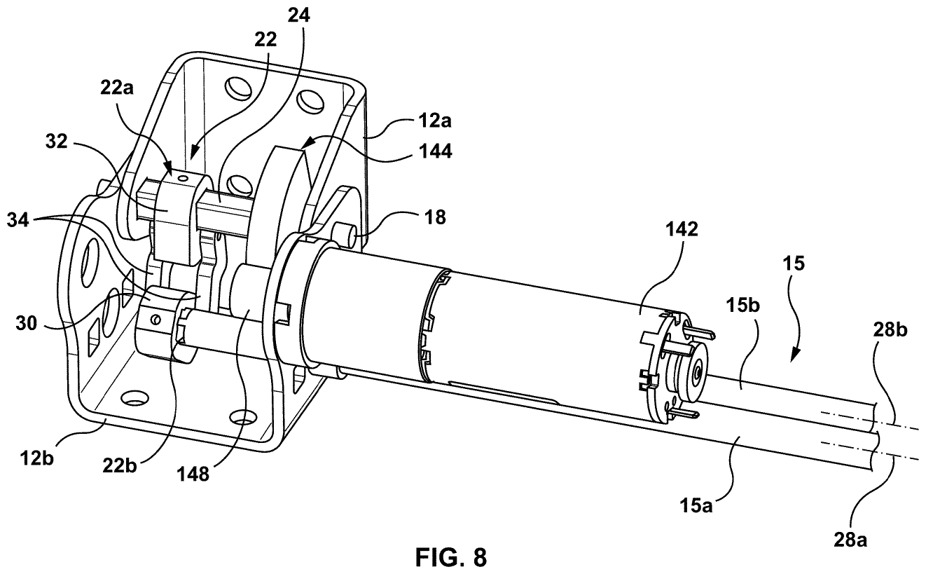

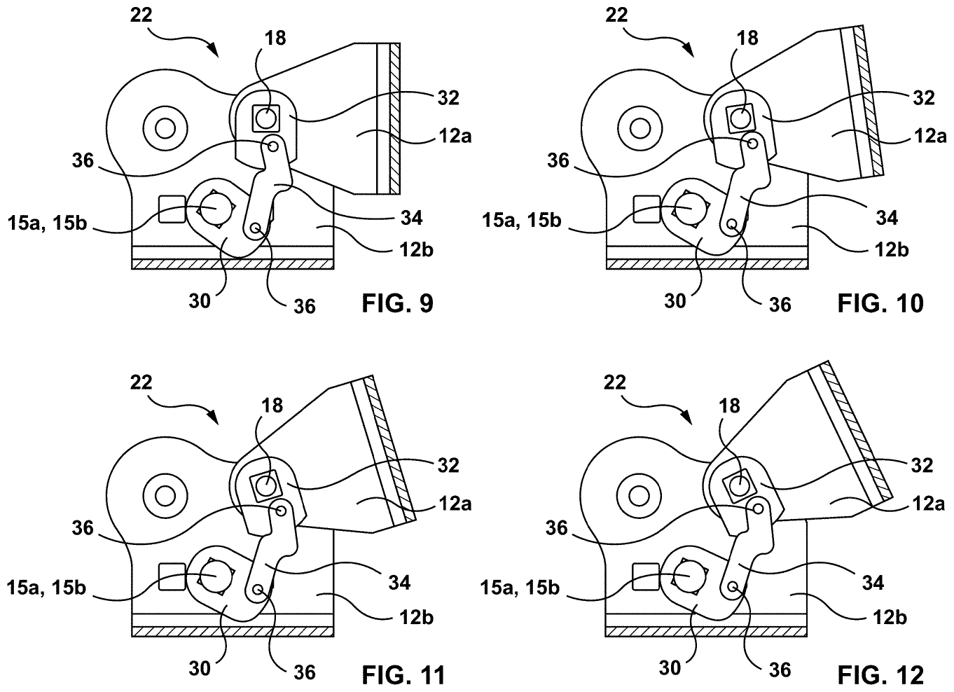

Referring to FIGS. 8 and 9, the mechanical coupling mechanism 22 (e.g. 4 bar) can have a first bar 30 mounted on the torsion element 15a, such that the first bar 30 rotates conjointly with the torsion element 15a. It is noted that the first bar 30 is positioned on the torsion element 15a adjacent to the aperture 26 of the body side portion 12b. As such, the first bar 30 pivots about the torsion axis 28a of the torsion element 15a. Further, the mechanical coupling mechanism 22 can have a second bar 32 mounted on the pivot member 24, such that motion of the first bar 30 is coupled to motion of the second bar 32. One example of the coupling between the first bar 30 and the second bar 32 can be a third bar 34 (e.g. shown as a pair of third bars 34 on either side of the second bar 32). As such, the first bar 30 can be coupled to the second bar 32 via joint(s) 36 and the third bar 34. Further, the mechanical coupling mechanism 22 can have a fourth bar represented by the body side portion 12b, with the pivot axis 18 and the torsion element 15 (at the free end 29) acting as others of the joints 36 making up the multi bar linkage as an embodiment of the mechanical coupling mechanism 22. As such, mechanical coupling mechanism 22 can include the first bar 30 and the second bar 32 for coupling rotational movement of the pivot member 24 about the pivot axis 18 (of the hinge 12) with rotational movement of the torsion element 15a about the torsion axis 28a, while at the same time providing for variability on the mechanical advantage applied between torsion element 15a and the pivot element 24. Alternatively, a cam system or variable (e.g. non-linear) ratio gear/belt/chain drive (not shown) could also be used as the mechanical coupling mechanism 22 to couple rotational movement of the pivot member 24 about the pivot axis 18 (of the hinge 12) with the rotational movement of the torsion element 15a about the torsion axis 28a, while at the same time providing for variability on the mechanical advantage applied between torsion element 15a and the pivot element 24.

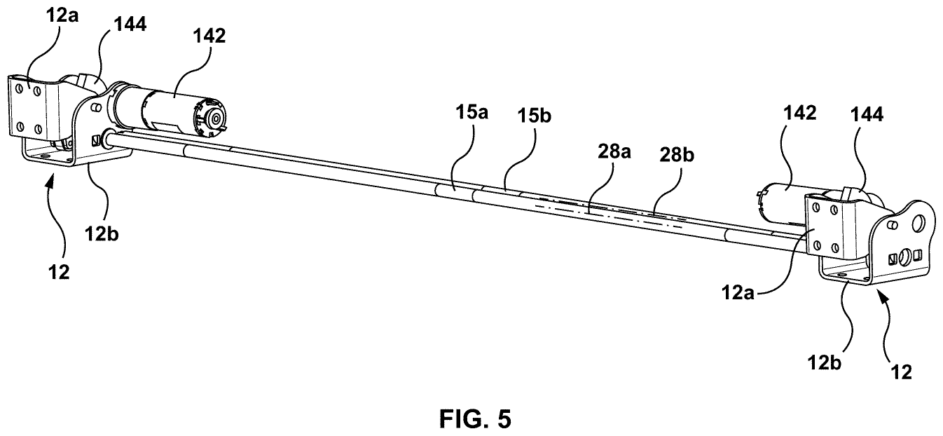

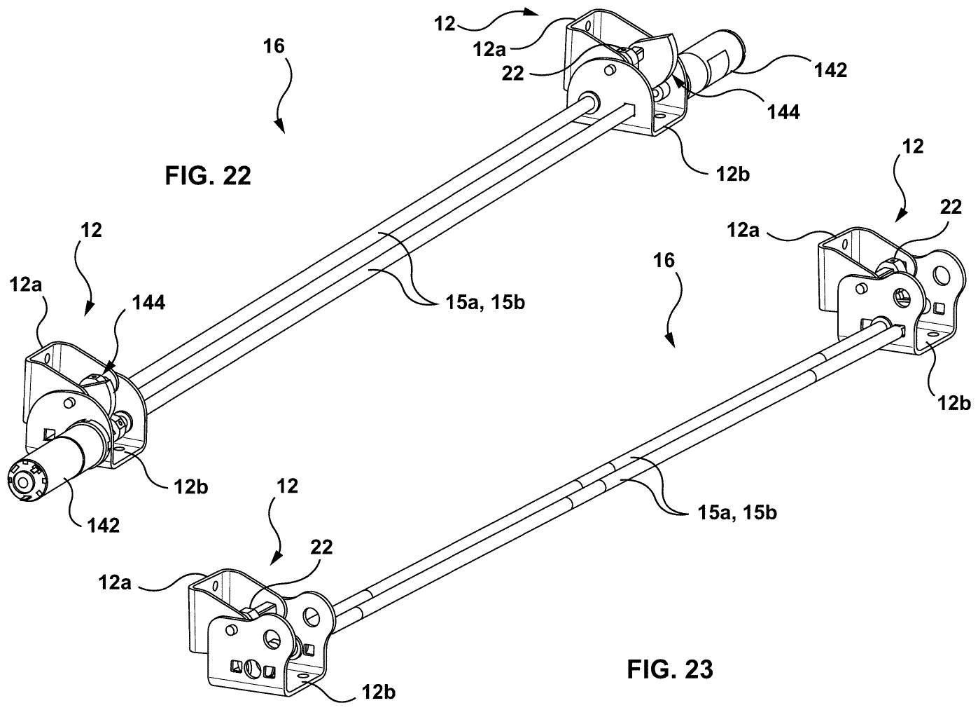

The hinge based counterbalance mechanism 16 can advantageously include the torsion elements 15 packaged near the hinge (i.e. pivot) axis 18. For example, a pair of torsion elements 15a,b are used—one providing torque to each hinge 12 of the pair of hinges 12 connecting the closure panel 14 to the vehicle body 11. The torsion element 15 output torque can be applied to the hinge 12 via the multi (e.g. 4) bar linkage (an example of the mechanical coupling mechanism 22). The use of the mechanical coupling mechanism 22 facilitates variability in mechanical advantage between the operational coupling of the torsion element 15a with the panel side portion 12a of the hinge 12, which provides as the closure panel 14 open/closes a match with the closure panel 14 torque curve and thus the provision of counterbalance. The torsion element 15 output torque as transferred via the mechanical coupling mechanism 22 may alternatively be applied directly to the closure panel 14, for example the second bar 32 of the mechanical coupling mechanism 22 may be coupled to a bracket mounted to the closure panel 14 or other mounting point to the closure panel 14. Because the closure panel 14 is facilitated as balanced, advantageously a smaller motor 142 and gear 144 can be packaged at the hinge 12 to provide the additional torque used to open/close the closure panel 14. The torsion element 15 counterbalance can reduce the size/power needed for the gear 144 and motor 142 assembly. It is also recognized that hinge based counterbalance mechanism 16 with the torsion elements 15 could be used as a manual only option (see FIG. 23), or combined with the gear 144 and motor 142 (see FIG. 5 and alternative embodiment of FIG. 22) for a powered system option. Advantageously, the hinge based counterbalance mechanism 16 can be resistant to moisture or temperature variability, due to the stability provided by torsion element 15, for example which may be illustratively manufactured using metal to provide thermal stability as an example.

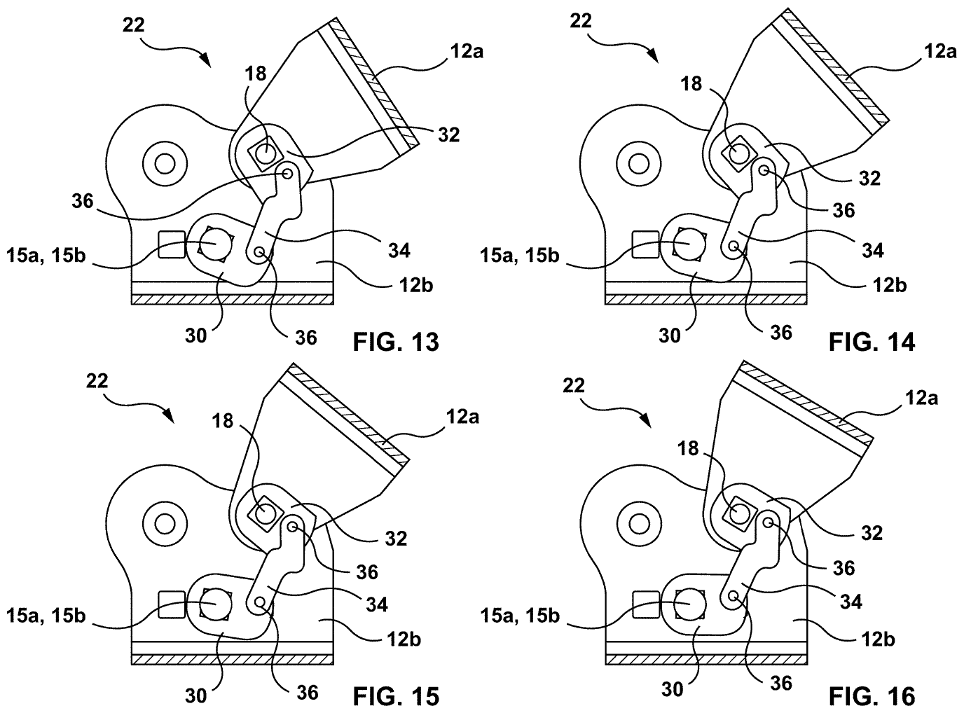

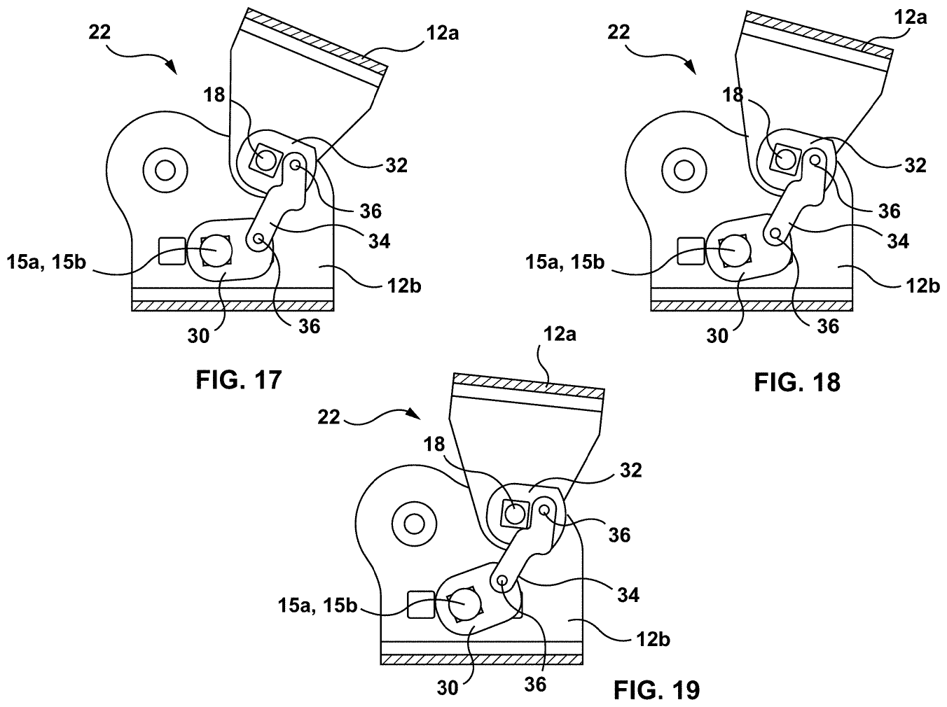

As such, the hinge based counterbalance mechanism 16 can be designed as a torsion rod system packaged near the hinge pivot axis 18 to provide the torques used to balance (i.e. counterbalance) the closure panel 14 at a plurality (e.g. all) opening/closing positions (see FIGS. 9-21 as operational examples). For example, as a torsion element 15 can have a linear torque output, while the closure panel 14 torque curve is non-linear, the use of the mechanical coupling system provides for the variability (i.e. non-linear output) in mechanical advantage between the torsion element 15 and the closure panel 14 via the panel side portion 12a of the hinge 12.

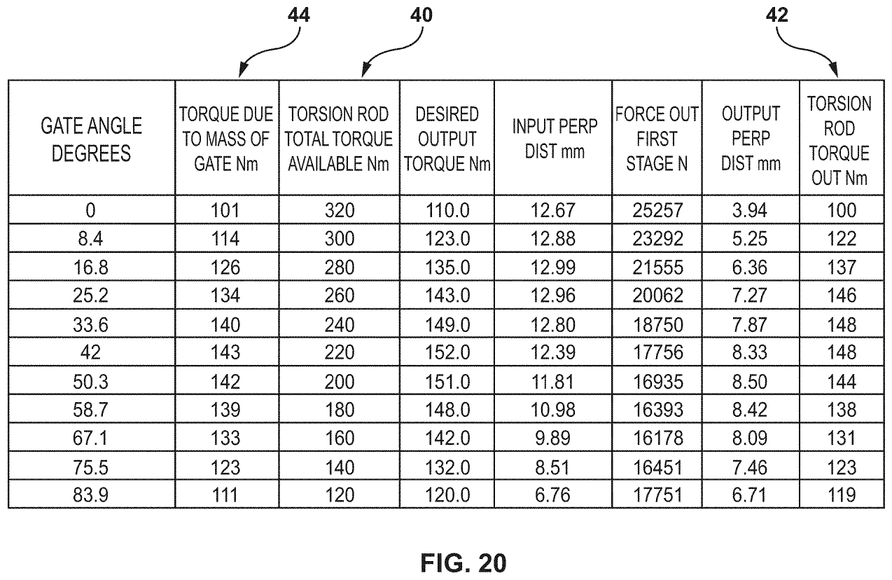

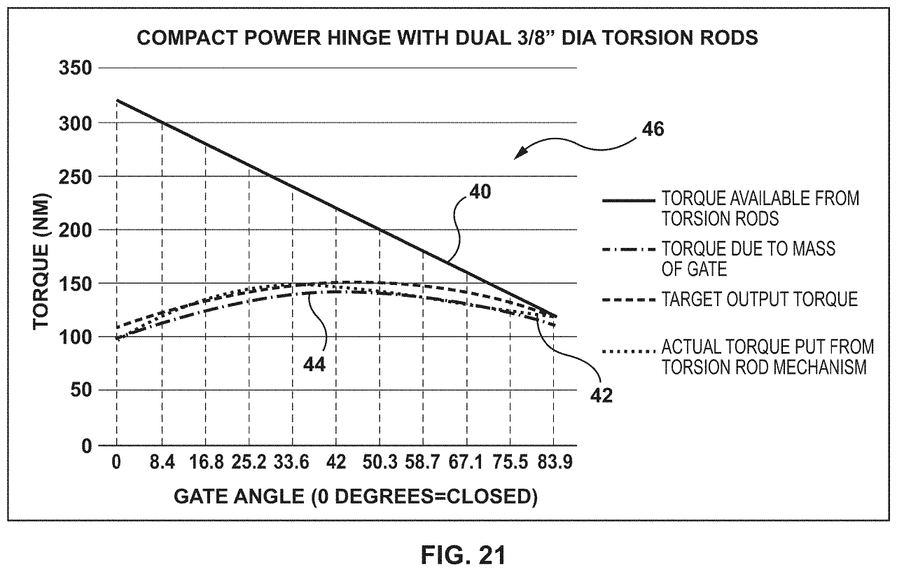

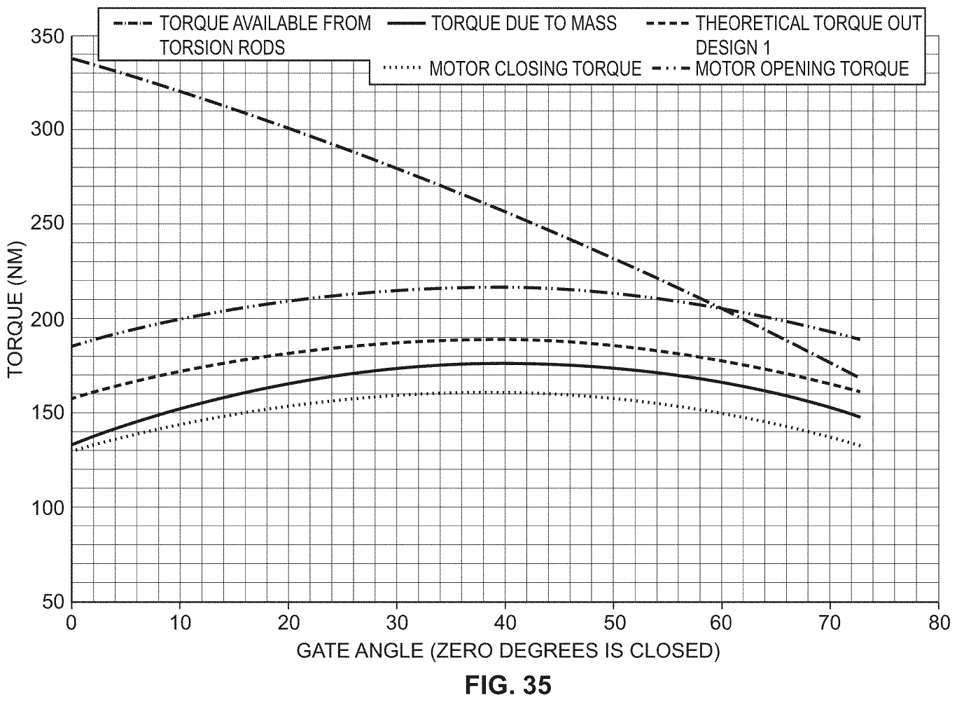

Referring to FIG. 9, shown is the hinge 12 in a closed position (e.g. 0 degrees), with the torque available 40 (see FIG. 20) from the torsion elements 15a,b at a maximum (for example). It can be seen from FIGS. 21, 35 that as the closure panel 14 opens further (e.g. from 0 to 83.9 degrees and from 0 to 73 degrees respectively), the torsion element 15a,b torque available 40 decreases consistently. In terms of the output torque 42 of the hinge based counterbalance mechanism 16, the output torque 42 increases to a maximum and then again decreases towards the fully open position (see FIGS. 19, 33 respectively), as a result of the variability in the mechanical advantage provided by the mechanical coupling mechanism 22 operating between the pivot element 24 and the torsion elements 15a,b (see FIGS. 8 and 9 and 36 respectively). As can be seen by example, the output torque 42 approximates the torque 44 due to the mass of the closure panel 14 (e.g. see FIG. 20) both in magnitude as well as rate of change (e.g. increases and then decreases from close to open). FIG. 21 shows a graphical representation 46 of the parameters 40, 42, 44 of FIG. 20.

Illustratively, referring to FIGS. 1B, 5, and 8, the motor 142 is controlled by a controller 143 in electrical communication therewith via signal lines 145 for issuing pulse width modulated control signals for controlling the rotational direction of the motor 142, the speed of the motor 142, the stopping of the motor 142 for obstacle detection, and other functionalities for controlling the movement of the closure panel 14. Other types of motors, such as brushless motors controlled using Field Oriented Control (vector control) techniques may also be provided, as an example. The controller 143 may draw power from a source of electric energy, such as the vehicle main battery 147.

In view of the above, the hinge based counterbalance mechanism 16 can be for operating hinges 12 of the closure panel 14 of the vehicle 10 to assist in opening and closing of the closure panel 14 between the closed position and the open position about the pivot axis 18. The hinge based counterbalance mechanism 16 can include: the first hinge 12 and the second hinge 12 each having the body side portion 12b for connecting to the body 11 of the vehicle 10 and the panel side portion 12a for connecting to the closure panel 14, the body side portion 12b and the panel side portion 12a coupled via the pivot axis 18 (e.g. via a pivot pin); a first torsion element 15a having a first fixed end 27 coupled to the body 11 and a first free end 29 coupled to the body side portion 12b of the first hinge 12, the first fixed end 27 inhibited from rotating relative to the first free end 29 and the first free end 29 able to rotate about the first torsion axis 28a of the first torsion element 15a; a second torsion element 15b having a second fixed end 27 coupled to the body 11 and a second free end 29 coupled to the body side portion 12b of the second hinge 12, the second fixed end 27 inhibited from rotating relative to the second free end 29 and the second free end 29 able to rotate about a second torsion axis 28b of the second torsion element 15b; a first mechanical coupling mechanism 22 coupling the first free end 29 to the panel side portion 12a of the first hinge 12, the first mechanical coupling mechanism 22 providing for variability in torque output of the first torsion element 15a applied from the first torsion element 15a to the panel side portion 12a of the first hinge 12 as the first hinge 12 moves between the open position and the closed position; and a second mechanical coupling mechanism 22 coupling the second free end 29 to the panel side portion 12a of the second hinge 12, the second mechanical coupling mechanism 22 providing for variability in torque output of the second torsion element 15b applied from the second torsion element 15b to the panel side portion 12a of the second hinge 12 as the second hinge 12 moves between the open position and the closed position.

Further, as shown, the first fixed end 27 can be mounted to the body side portion 12b of the hinge 12 and the second fixed end 27 can be mounted to the body side portion of the other hinge 12. Alternatively, the fixed ends 27 can be mounted directly to the body 11 rather than indirectly via the body side portion 12b (not shown). In any event, it is recognized that the fixed end 27 is inhibited from rotating relative to the free end 29. As described above by example, the pivot element 24 can be fixedly attached to the panel side portion 12a about the pivot axis 18.

An alternative embodiment, not shown, is where one hinge 12 is used to couple to body 11 to the closure panel 14. In this regard, the hinge based counterbalance mechanism 16 can be for operating hinge 12 of the closure panel 14 of the vehicle 10 to assist in opening and closing of the closure panel 14 between the closed position and the open position about the pivot axis 18. The hinge based counterbalance mechanism 16 can include: the hinge 12 having the body side portion 12b for connecting to the body 11 of the vehicle 10 and the panel side portion 12a for connecting to the closure panel 14, the body side portion 12b and the panel side portion 12a coupled via the pivot axis 18 (e.g. via a pivot pin); a torsion element 15a having a fixed end 27 coupled to the body 11 and a free end 29 coupled to the body side portion 12b, the fixed end 27 inhibited from rotating relative to the free end 29 and the free end 29 able to rotate about the torsion axis 28a of the torsion element 15a; and a mechanical coupling mechanism 22 coupling the free end 29 to the panel side portion 12a, the mechanical coupling mechanism 22 providing for variability in torque output of the torsion element 15a applied from the torsion element 15a to the panel side portion 12a as the hinge 12 moves between the open position and the closed position.

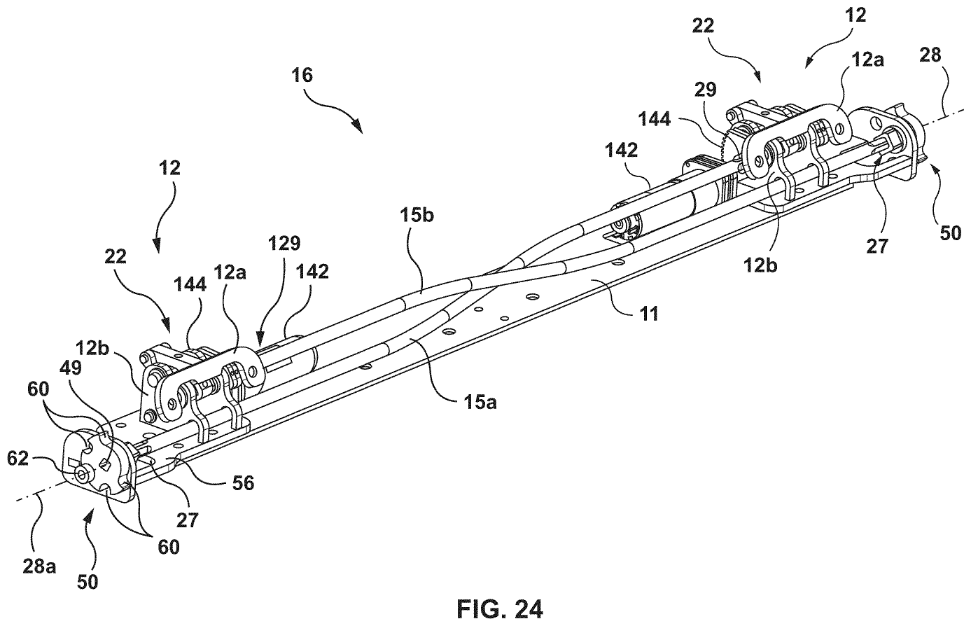

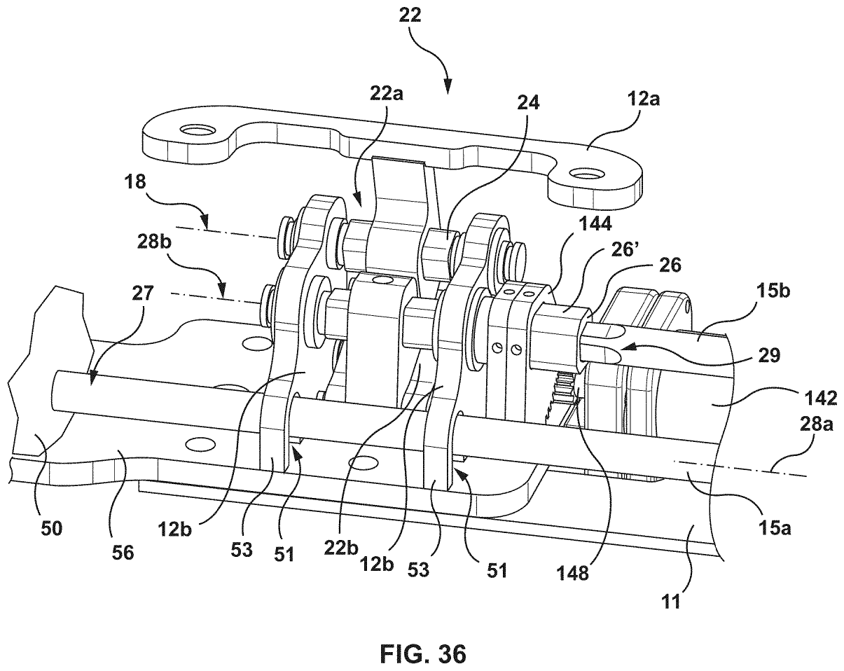

Referring to FIGS. 24 and 36, shown is a further embodiment of the hinge based counterbalance mechanism 16 having the pair of torsion elements 15a (e.g. one for each hinge 12) coupled on one end to the hinge 12 and on the other end to the other hinge 12. As shown by example, the torsion elements 15 are coupled to the body side portions 12b of the hinges 12. Each hinge 12 can have the electrically driven motor 142 coupled (via the drive shaft 148) to the panel side portion 12a of the hinges 12 via the gear 144 (e.g. one or more gears). As shown in FIG. 36, the gear 144 is coupled to the body side portion 12b via mount member 26′ (e.g. external to the hinge 12) to the other end 22b of the mechanical coupling mechanism 22 (e.g. 4 bar linkage), such that rotation (e.g. as driven by the drive shaft 148) of the gear 144 about the mount member 26′ also results in conjoint rotation of the panel side portion 12a also about the pivot axis 18. It is recognized that the mechanical coupling mechanism 22 is driven by the rotation of the gear 144 via the mount member 26′ about the torsion axis 28b. As further described below, as the panel side portion 12a rotates about the pivot axis 18, the respective torsion element 15 associated with each hinge 12 is twisted or untwisted, thus loading or unloading (depending on the direction of rotation) torque of the torsion element 15. It is recognized that at one free end 29 the torsion element 15 is allowed to rotate (about respective torsion axis 28a,b) in an aperture 26 (of the mount 26′ connected to one body side portion 12b of the pair of hinges 12) while at the other fixed end 27 the torsion element 15 is fixedly mounted to a mounting bracket 50 positioned adjacent to the other body side portion 12b of the pair of hinges 12 (see FIG. 24) and thus inhibited from rotating.

As shown in FIGS. 24 and 36, the hinge 12 has the motor 142 mounted on the body side portion 12b (or on the vehicle body 11 adjacent to the panel side portion 12b) and coupled operationally to the panel side portion 12a (e.g. via the gear 144 and drive shaft 148) about the torsion axis 28b via the mount member 26′. The gear 144 is connected to the mount member 26′ mounted to the body side portion 12b about the torsion axis 28b, such that both the mount member 26′ and the other end 22b of the mechanical coupling mechanism 22 move (e.g. rotate) conjointly, as one example of the operational coupling between the motor 142 and the panel side portion 12a of the hinge 12. The mechanical coupling mechanism (e.g. a multi bar linkage) 22 is connected to the pivot member 24 at one end 22a and to one of the torsion elements 15b at the other end 22b, thus providing variability in mechanical advantage between the torsion element 15b and the panel side portion 12a of the hinge 12. It is recognized that the torsion element 15b is positioned in the aperture 26 of the mount member 26′ coupled to the body side portion 12b, such that the torsion element 15b is free to rotate about itself (e.g. along torsion axis 28b) at the one free end 29.

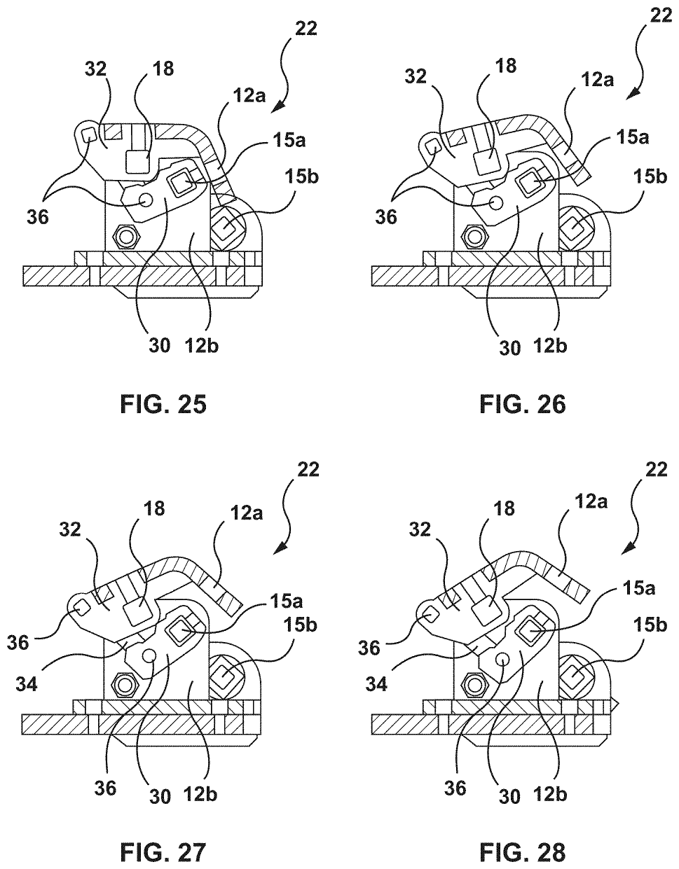

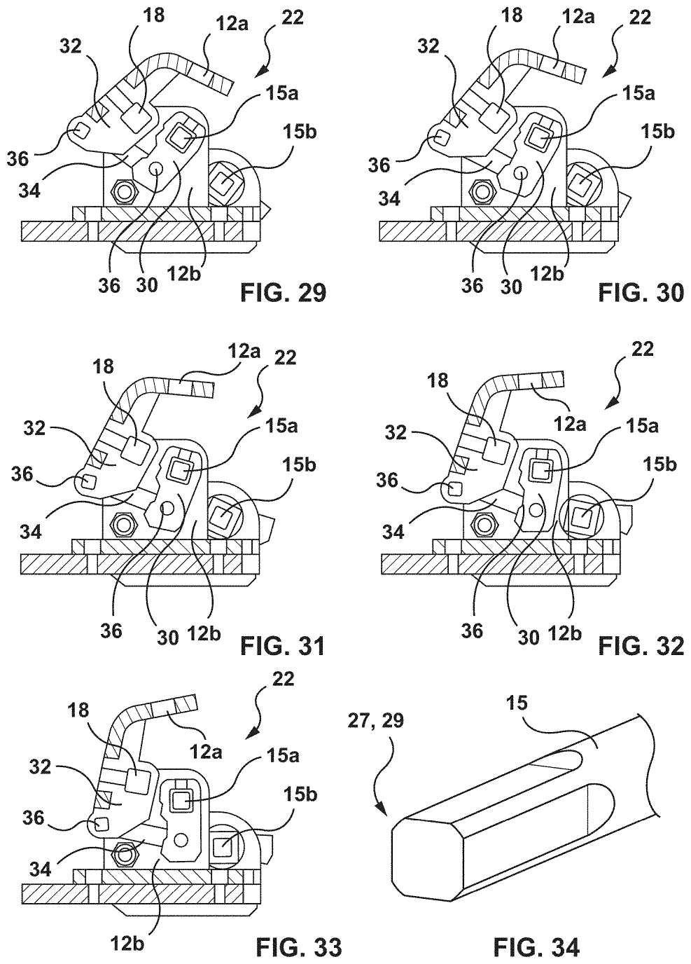

Referring to FIGS. 25 through 33, the mechanical coupling mechanism 22 (e.g. 4 bar) can have the first bar 30 mounted on the torsion element 15a, such that the first bar 30 rotates conjointly with the torsion element 15a. It is noted that the first bar 30 is positioned on the torsion element 15a adjacent to the aperture 26 of the mount member 26′. As such, the first bar 30 pivots about the torsion axis 28a of the torsion element 15a. Further, the mechanical coupling mechanism 22 can have the second bar 32 mounted on the pivot member 24, such that motion of the first bar 30 is coupled to motion of the second bar 32. One example of the coupling between the first bar 30 and the second bar 32 can be a third bar 34 (e.g. shown as a pair of third bars 34 on either side of the second bar 32). As such, the first bar 30 can be coupled to the second bar 32 via joint(s) 36 and the third bar 34. Further, the mechanical coupling mechanism 22 can have a fourth bar represented by the body side portion 12b, with the pivot axis 18 and the torsion element 15 (at the free end 29) acting as others of the joints 36 making up the multi bar linkage as an embodiment of the mechanical coupling mechanism 22. As such, mechanical coupling mechanism 22 can include the first bar 30 and the second bar 32 for coupling rotational movement of the pivot member 24 about the pivot axis 18 (of the hinge 12) with rotational movement of the torsion element 15a about the torsion axis 28a, while at the same time providing for variability on the mechanical advantage applied between torsion element 15a and the pivot element 24. Alternatively, a cam system or variable (e.g. non-linear) ratio gear/belt/chain drive (not shown) could also be used as the mechanical coupling mechanism 22 to couple rotational movement of the pivot member 24 about the pivot axis 18 (of the hinge 12) with the rotational movement of the torsion element 15a about the torsion axis 28a, while at the same time providing for variability on the mechanical advantage applied between torsion element 15a and the pivot element 24.

In view of the above, referring to FIGS. 24 and 36, the hinge based counterbalance mechanism 16 can be for operating hinges 12 of the closure panel 14 of the vehicle 10 to assist in opening and closing of the closure panel 14 between the closed position and the open position about the pivot axis 18. The hinge based counterbalance mechanism 16 can include: the first hinge 12 and the second hinge 12 each having the body side portion 12b for connecting to the body 11 of the vehicle 10 and the panel side portion 12a for connecting to the closure panel 14, the body side portion 12b and the panel side portion 12a coupled via the pivot axis 18 (e.g. via a pivot pin); a first torsion element 15a having a first fixed end 27 coupled to the body 11 (e.g. via mounting bracket 50) and a first free end 29 mounted to the body side portion 12b of the first hinge 12 via the mounting member 26′, the first fixed end 27 inhibited from rotating relative to the first free end 29 and the first free end 29 able to rotate about the first torsion axis 28a of the first torsion element 15a; a second torsion element 15b having a second fixed end 27 coupled to the body 11 and a second free end 29 coupled to the body side portion 12b of the second hinge 12 via the mounting member 26′, the second fixed end 27 inhibited from rotating relative to the second free end 29 and the second free end 29 able to rotate about a second torsion axis 28b of the second torsion element 15b; a first mechanical coupling mechanism 22 coupling the first free end 29 to the panel side portion 12a of the first hinge 12, the first mechanical coupling mechanism 22 providing for variability in torque output of the first torsion element 15a applied from the first torsion element 15a to the panel side portion 12a of the first hinge 12 as the first hinge 12 moves between the open position and the closed position; and a second mechanical coupling mechanism 22 coupling the second free end 29 to the panel side portion 12a of the second hinge 12, the second mechanical coupling mechanism 22 providing for variability in torque output of the second torsion element 15b applied from the second torsion element 15b to the panel side portion 12a of the second hinge 12 as the second hinge 12 moves between the open position and the closed position.

Further, as shown, the fixed end 27 can pass through the body side portion 12b of the hinge 12, e.g. via passages 51 formed via supports 53 connected to the body side portion 21b, and thus be mounted to the mounting bracket 50. The mounting bracket 50 can be mounted to the body 11 and/or to the body side portion 12b via extension 56. The mounting bracket 50 can be fixed in position, or can be variable in position about the torsion axis 28a,b, as desired. In the case of variable positioning, rotation of the mounting bracket 50 about the torsion axis 28a,b can be used to set a minimum degree (at fully closed position of the closure panel 14) of torsion in the torsion element 15a,b. For example, the mounting bracket 50 can have a series of notches 60 in a periphery of the mounting bracket, with a set pin 62 (received in a selected notch 60) for retaining the mounting bracket 50 at a set rotation about the torsion axis 28a,b. As shown in FIG. 34, the end 27, 29 of the torsion element 15 can have series of facets 66 (or other features such as splines) for use as retaining mechanism to inhibit rotational slippage between the end 29 and the aperture 26 as well as between the end 27 and the mounting bracket 50. In other words, the retaining mechanism (e.g. facets 66) helps to maintain the conjoint movement for the other end 22b and the free end 29 of the torsion element 15, as the mount member 26′ is rotated via rotation of the gear 144. Similarly, the retaining mechanism (e.g. facets 66) helps to inhibit movement of the fixed end 27 of the torsion element 15 when mounted in a corresponding aperture 49 of the mounting bracket 50.

In view of the above, it is recognized that the further embodiment of the torsion mechanism 16 shown in FIGS. 24 and 36 can have a number of features, such as but not limited to: 1) the torsion of the torsion element 15 is adjustable using the mounting bracket 50; 2) the mechanical coupling mechanism 22 can act directly on the hinge 12; 3) the gear 144 is positioned adjacent to and thus exterior to the hinge 12; 4) the torsion element 15 at the fixed end 27 can extend through the hinge 12 and thus be inhibited from rotation by the mounting bracket 50 positioned adjacent to the hinge 12; 5) the torsion elements 15a,b can be arcuate in length along the torsion axis 28a,b (rather than linear), thus for facilitating interference in positioning of the torsion elements 15 as the hinge 12 operates between the open and closed positions, and also for accommodating packaging space along the perimeter of the opening 13, for example a curved perimeter of the opening 13 closed by the closure panel 14 such that the torsion elements 15 do not extend over and block a portion of the opening 13 thereby reducing the ingress and egress area provided by the opening 13; and 6) the torsion elements 15 at their fixed ends 27 extend past the hinges 12 in order to facilitate increasing the torsion element output forces (e.g. the degree of output force is proportional to the length of the torsion elements 15). Further, for example, the material of the torsion elements 15 can be oil tempered chrome silicon to provide for desired resistance to shock and heat.

In the above examples, it is recognized that the torsion elements 15a,b rotate about the torsion axis 28a,b along the length of the torsion elements 15a,b.

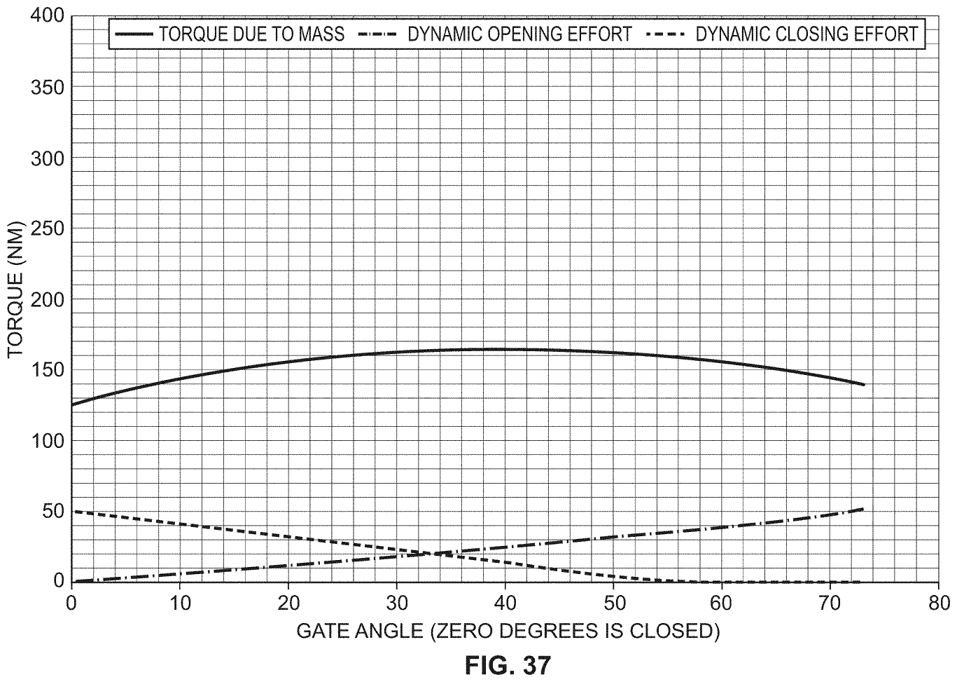

FIG. 37 shows a graph of torque (Nm) vs. gate angle (e.g. closure panel 14 angle) for torque due to mass of the closure panel 14, dynamic opening effort and dynamic closing effort.

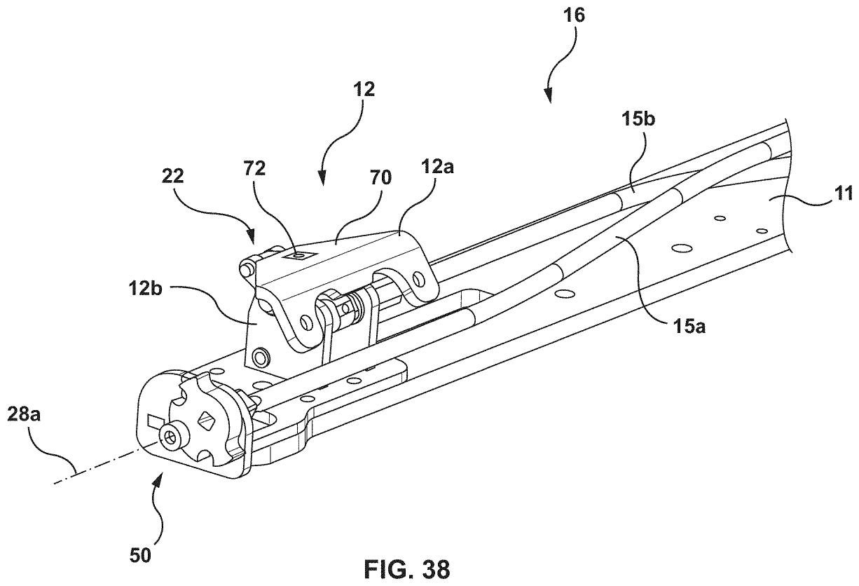

Referring to FIG. 38 shown are further alternative embodiments of the hinge mechanism 16, including a reinforced panel side portion 12b with leg 70 connected at fastener 72 to the mechanical coupling mechanism 22. Further, the supports 53 (see FIG. 24) are absent, thus facilitating the torsion element 15a to bend more naturally (e.g. unconstrained by the passages 51) in the vicinity of the hinge 12. Further, the mounting bracket 50 can be angled with respect to the body side portion 12b in order to help minimize undesirable bending (e.g. along the torsion axis 28a) in the torsion element 15a. 9. The mounting bracket 50 provides a torsion setting of the torsion element 15a,b as adjustable via movement of the mounting bracket 50 (e.g. via positioning of the set pin 62 within a selected notch 60).

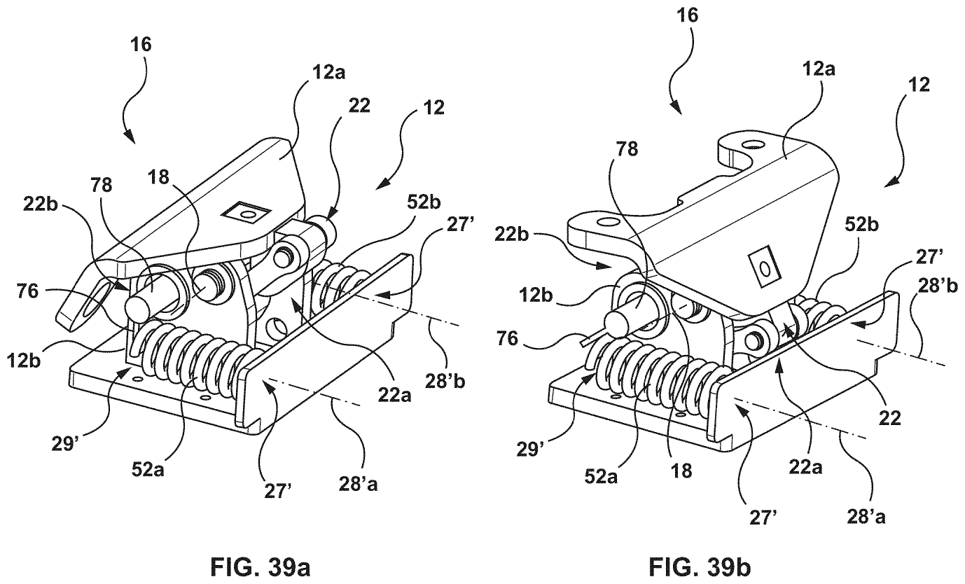

Referring to FIGS. 39a and 39b, shown is a further alternative embodiment to the hinge 12 of the counterbalance mechanism 16 of FIG. 4b. In particular, the hinge 12 has a pair of resilient elements 52a and 52b (e.g. coil spring) positioned to either side of the body side portion 12b. In FIG. 39a, the hinge 12 is in the closed position and therefore the resilient elements 52a,b can be in a compressive state. In FIG. 39a, the hinge is in the open position and therefore the resilient elements 52a,b can be in a compressive, neutral or tension state, as desired. The resilient elements 52a,52b are mounted at a fixed end 27′ to the body 11 and/or the body side portion 12b. A free end 29′ of the resilient elements 52a,b is coupled to the mechanical coupling mechanism 22 at end 22b, e.g. by tab 76 of pin 78. Accordingly, as the panel side portion 12a rotates about pivot axis 18 (as connected to end 22a), the pin 78 is rotated by the motion of the mechanical coupling mechanism 22 thereby allowing the resilient element 52a,b to elongate (e.g. to decompress) and thereby provide opening force assistance to the closure panel 14 (see FIG. 1), as the hinge 12 moves from the closed position to the open position. In this embodiment, it is recognized that the resilient elements 52a,b elongate and contract along a travel axis 28′a, 28′b. The resilient element 52a,b has the fixed end 27′ coupled to the body 11 and the free end 29′, the fixed end 27′ inhibited from translating relative to the free end 29′ and the free end 29′ able to translate along the travel axis 28′a,28′b of the resilient element 52a,b.

Referring to FIG. 40, shown is a still further embodiment of the hinge 12 of FIG. 4b. In this embodiment, the hinge 12 has a resilient element 54 (e.g. a torsion spring also referred to as a torsion element) coupled (e.g. affixed to pin 78) at a free end 29″ to the end 22b of the mechanical coupling mechanism 22 and at a fixed end 27″ to the body 11 and/or the body side portion 12b of the other hinge 12 of the hinge counterbalance mechanism 16 (see FIG. 4b). For example, as the mechanical coupling mechanism 22 moves while panel side portion 12a rotates about the pivot axis 18, the pin 78 rotates and thus the resilient element 54 is either wound or unwound depending upon the angle of open of the hinge 12. For example, when the hinge 12 is in the closed position, the resilient element 54 can have stored torsion energy, which is communicated to the pin 78 as the closure panel 14 is opened, which is used to rotate the pin 78 and thus drive the mechanical coupling mechanism 22 in order to assist in opening of the closure panel 14 via the panel side portion 12a. In closing of the closure panel 14, the closure panel 14 moves the mechanical coupling mechanism 22 and thus rotates the pin 78, which in turn rotates the resilient element 54 and thus stores energy in the resilient element 54 as the closure panel moves to the closed position. In this embodiment, it is recognized that the resilient element 54 rotates about a torsion axis 28″ along the length of the resilient elements 54.

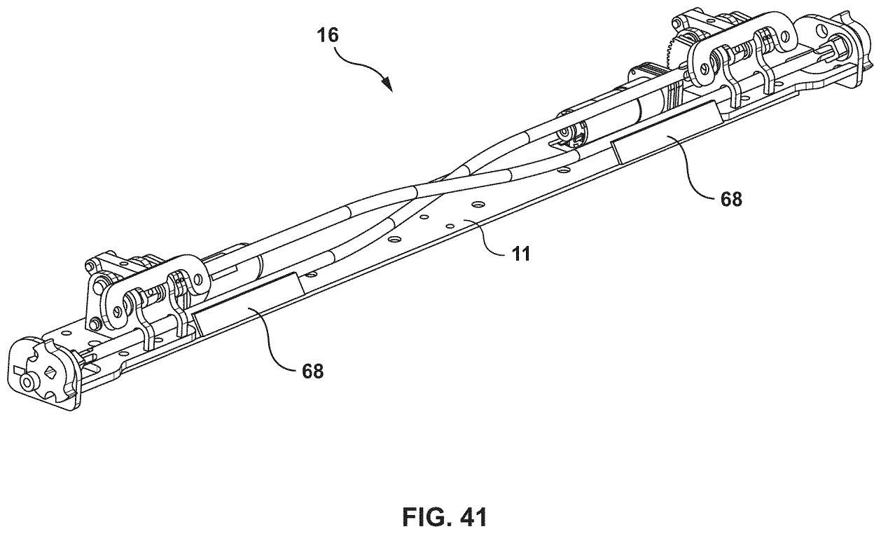

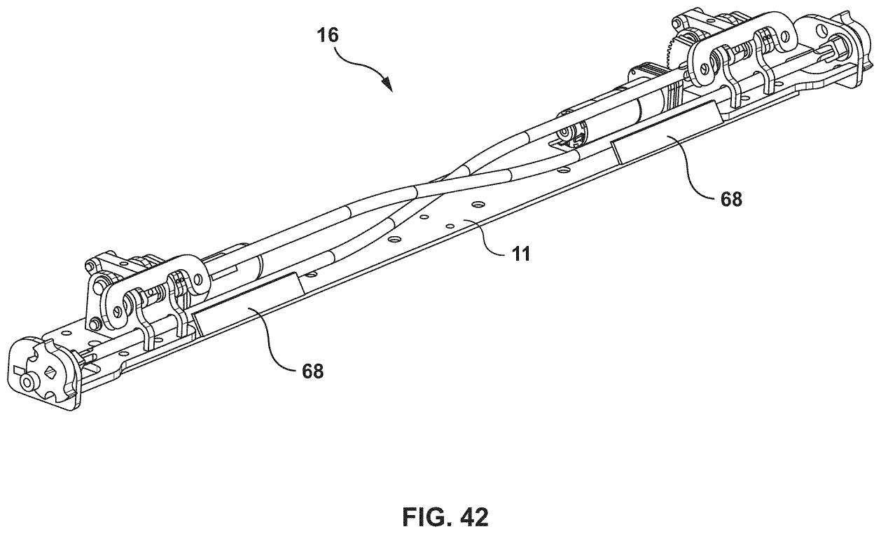

Referring to FIGS. 41 and 42, shown are electrical components 68 mounted to the body 11 of the vehicle 10 (see FIG. 1). For example, the electrical components 68 can be embodied as sensor assemblies (e.g. radar, ultrasonic, capacitive, camera) in order to detect various parameters associates with operation of the hinges 12, for example gesture detection to open/close the closure panel 14, for non-contact obstacle detection on closure panel opening/closing, and/or as a light curtain to detect obstacles. Alternatively or in addition to, the electrical components 68 can also be used as lighting assemblies for logo detection and/or lighting of the opening area of the closure panel 14.

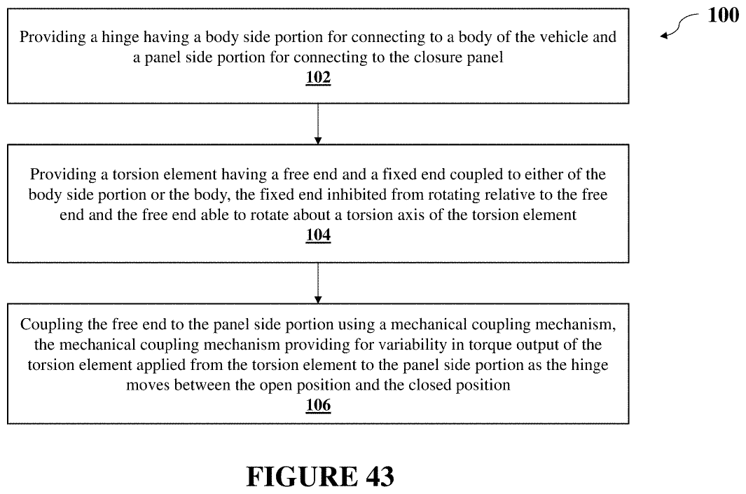

Now referring to FIG. 43, there is illustrated a method of opening and closing a closure panel of a vehicle between a closed position and an open position 100, including the steps of providing a hinge having a body side portion for connecting to a body of the vehicle and a panel side portion for connecting to the closure panel 102, providing a torsion element having a free end and a fixed end coupled to either of the body side portion or the body, the fixed end inhibited from rotating relative to the free end and the free end able to rotate about a torsion axis of the torsion element 104, and coupling the free end to the panel side portion using a mechanical coupling mechanism, the mechanical coupling mechanism providing for variability in torque output of the torsion element applied from the torsion element to the panel side portion as the hinge moves between the open position and the closed position 106.

We claim:

1. A method of opening and closing a closure panel of a vehicle between a closed position and an open position, comprising the steps of:
providing a hinge having a body side portion (12b) for connecting to a body (11) of the vehicle and a panel side portion (12a) for connecting to the closure panel;
providing a torsion element (15a) having a free end (29) and a fixed end (29) coupled to either of the body side portion or the body, the fixed end inhibited from rotating relative to the free end and the free end able to rotate about a torsion axis (28a) of the torsion element; and
coupling the free end to the panel side portion using a mechanical coupling mechanism (22), the mechanical coupling mechanism providing for variability in torque output of the torsion element applied from the torsion element to the panel side portion as the hinge moves between the open position and the closed position.
